(19) United States
(12) Patent Application Publication
(10) Pub. No.: US 2020/0388801 A1
(43) Pub. Date: Dec. 10, 2020

(54) BATTERY MODULE

(71) Applicant: Panasonic Intellectual Property Management Co., Ltd., Osaka (JP)

(72) Inventor: Tetsuji OMURA, Osaka (JP)

(21) Appl. No.: 16/317,506

(22) PCT Filed: Jul. 4, 2017
(86) PCT No.: PCT/JP2017/024473

§ 371 Date: Jan. 11, 2019

(30) Foreign Application Priority Data
Jul. 12, 2016 (JP) 2016-137774

(51) Int. Cl. H01M 2/10

(52) U.S. Cl. CPC H01M 2/1077; H01M 2220/20; H01M 2/1083

(57) ABSTRACT

A battery module includes a battery stack having a plurality of stacked batteries and a pair of end plates disposed on both ends of the battery stack in a stacking direction in which the batteries are stacked. End plates each include two thin-walled parts at both ends in a direction perpendicular to the stacking direction X and a thick-walled part disposed between the two thin-walled parts. The thick-walled part is thicker than the thin-walled parts in the stacking direction. The battery module further includes a pair of restraint members each including stacked parts stacked on surfaces of the thin-walled parts remote from the battery stack and fasteners to fasten the stacked part of the one restraint member to the one thin-walled part and to fasten the stacked part of the other restraint member to the other thin-walled part.

### CROSS-REFERENCE OF RELATED APPLICATIONS

This application is the U.S. National Phase under 35 U.S.C. § 371 of International Patent Application No. PCT/JP2017/024473, filed on Jul. 4, 2017, which in turn claims the benefit of Japanese Application No. 2016-137774, filed on Jul. 12, 2016, the entire disclosures of which Applications are incorporated by reference herein.

### TECHNICAL FIELD

The present invention relates to a battery module.

### BACKGROUND ART

It is known that a battery module made up of a plurality of batteries connected in series serves as a power supply for vehicles or other uses that require high output voltage, for example. PTL 1 discloses a power storage module that includes a battery stack incorporating a plurality of stacked flat batteries, a pair of end plates disposed on both ends of the battery stack, a pair of restraint members between which the battery stack and the pair of the end plates are put, and bolts to fasten the restraint members to main surfaces of the end plates.

### CITATION LIST

### Patent Literature

PTL 1: Unexamined Japanese Patent Publication No. 2015-99648

### SUMMARY OF THE INVENTION

In recent years, battery modules have been required to offer higher output voltages. To satisfy this demand, numbers of batteries stacked in battery modules are on the increase. Meanwhile, the battery module gets larger with an increase in the number of the stacked batteries. Thus, demand for downsizing of battery modules is also growing.

The present invention has been accomplished in light of this situation. It is an object of the present invention to provide a technique for downsizing a battery module.

A battery module is provided in accordance with an aspect of the present invention. The battery module includes a battery stack having a plurality of stacked batteries and a pair of end plates disposed on both ends of the battery stack in a stacking direction in which the batteries are stacked. The end plates each include two thin-walled parts at both ends in a direction perpendicular to the stacking direction and a thick-walled part disposed between the two thin-walled parts. The thick-walled part is thicker than the thin-walled parts in the stacking direction. The battery module further includes a pair of restraint members each including a stacked part stacked on a surface of each of the thin-walled parts remote from the battery stack and a fastener to fasten the stacked part of one of the restraint members to one of the thin-walled parts and to fasten the stacked part of the other of the restraint members to the other of the thin-walled parts. The battery stack and the pair of the end plates are sandwiched between the pair of the restraint members in the stacking direction.

A battery module according to the present invention can come down in size.

### BRIEF DESCRIPTION OF DRAWINGS

FIG. 1 is a schematic perspective view illustrating a structure of a battery module according to an exemplary embodiment.

FIG. 2 is a perspective view of the battery module from which a covering is removed.

FIG. 3 is a schematic perspective view illustrating a structure of a battery.

FIG. 4 is a schematic perspective view illustrating a structure of a separator.

FIG. 5 is a schematic perspective view illustrating a structure of an end plate.

FIG. 6 is a schematic perspective view illustrating a structure of a restraint member.

FIG. 7A is a schematic plan view illustrating a structure of a battery module according to a comparative example. FIG. 7B is a schematic plan view illustrating the structure of the battery module according to the exemplary embodiment.

FIG. 8A is a schematic view for illustrating a relationship among thicknesses of a thin-walled part, a thick-walled part, a stacked part, and a protrusion. FIG. 8B is a graph illustrating a variation in a length of a battery module and a variation in a weight of an end plate in response to a change in a difference between the thicknesses of the thin-walled part and the thick-walled part.

### DESCRIPTION OF EMBODIMENT

Hereinafter, the present invention will be described based on preferred exemplary embodiments with reference to the drawings. The exemplary embodiments are exemplifications and should not limit the invention. All the features described in the exemplary embodiments and a combination thereof are not necessarily essential to the invention. Identical reference marks are assigned to identical or equivalent components, members, processes illustrated in the drawings, and the repeated description thereof is omitted as appropriate. Further, scales or shapes of parts illustrated in the drawings are conveniently set to facilitate the description, and should not be interpreted restrictively unless otherwise mentioned. Even identical members may slightly differ from each other in scale or extent between the drawings. Additionally, the terms “first”, “second”, and the like used in the present description and claims should not represent any order or importance, but are intended to distinguish between one configuration and another configuration.

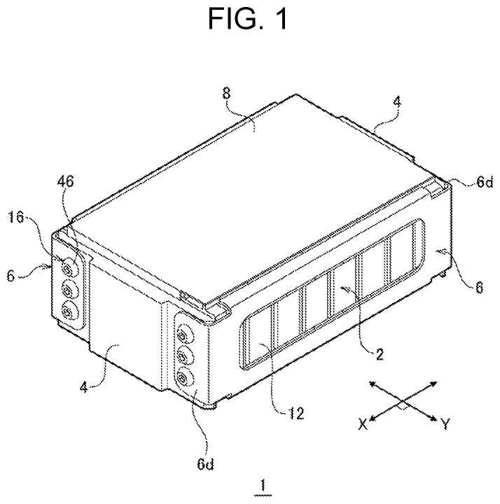

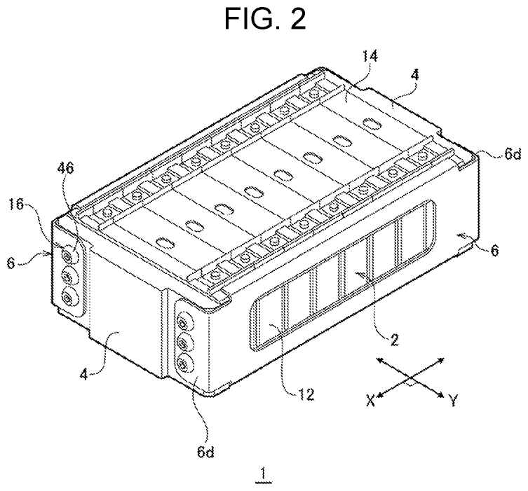

FIG. 1 is a schematic perspective view illustrating a structure of a battery module according to an exemplary embodiment. FIG. 2 is a perspective view of the battery module from which a covering is removed. Battery module 1 chiefly includes battery stack 2, a pair of end plates 4, a pair of restraint members 6, covering 8, and fasteners 16. Battery stack 2 includes a bus bar (not shown) and a plurality of batteries 12 that are electrically connected with each other by the bus bar. In the present exemplary embodiment, for example, eight batteries 12 are connected in series by bus bars, whereby battery stack 2 is formed.

For example, each battery 12 is a rechargeable secondary battery, such as a lithium ion battery, a nickel-hydrogen battery, or a nickel-cadmium battery. Battery 12 is a so-called prismatic battery. The plurality of batteries 12 is stacked at predetermined intervals such that main surfaces of adjacent batteries 12 face each other. The “stack” herein denotes that a plurality of components is arranged in any one direction. Thus, the scope of “stacked batteries 12” includes cases in which the plurality of batteries 12 is arranged in a horizontal direction. A positive electrode terminal of one of two adjacent batteries 12 is electrically connected with a negative electrode terminal of the other battery via a bus bar. The bus bar is a strip-shaped metal plate, for example. One end of the bus bar is electrically connected in series to the positive electrode terminal of one battery 12, and the other end of the bus bar is electrically connected in series to the negative electrode terminal of other battery 12. Two adjacent batteries 12 may be arrayed such that positive electrode terminal 22a of one battery 12 is adjacent to positive electrode terminal 22a of other battery 12. For example, if two adjacent batteries 12 are in parallel connection, batteries 12 are arrayed such that output terminals 22 of an identical polarity are adjacent to each other.

Battery stack 2 includes a plurality of separators 14. Separator 14 is also called an insulating spacer and is formed of resin having an insulation property, for example. Separator 14 is disposed between batteries 12 and between battery 12 and end plate 4.

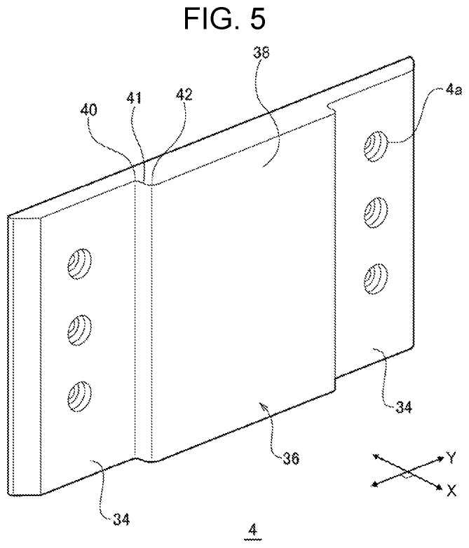

Battery stack 2 is sandwiched between the pair of end plates 4. The pair of end plates 4 is disposed on both ends of battery stack 2 in stacking direction X in which batteries 12 are stacked (a direction indicated by arrow X in FIGS. 1 and 2). Thus, end plates 4 are disposed so as to be adjacent to respective outermost batteries 12. End plate 4 is made of a metal plate, for example, and is insulated from battery 12 since end plate 4 is adjacent to battery 12 with separator 14 interposed therebetween. A main surface of end plate 4 is provided with screw holes 4a (see FIG. 5) into which fasteners 16 are screwed.

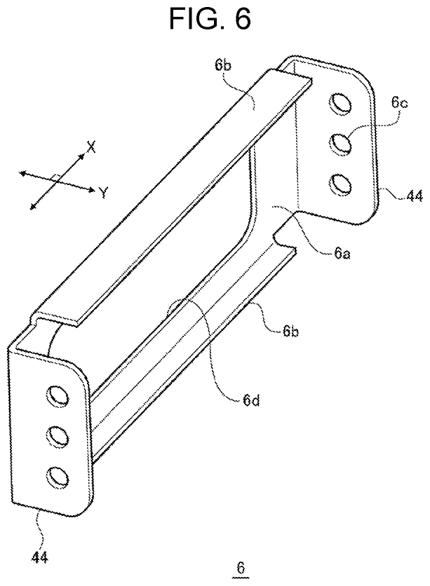

The pair of restraint members 6 is arrayed in direction Y (a direction indicated by arrow Y in FIGS. 1 and 2) perpendicular to stacking direction X in which the plurality of batteries 12 and the pair of end plates 4 are stacked. Battery stack 2 and the pair of end plates 4 are disposed between the pair of restraint members 6. Each restraint member 6 has a pair of stacked parts 44 that is stacked on surfaces of end plates 4 remote from battery stack 2. The pair of stacked parts 44 is opposed to each other in stacking direction X in which battery stack 2 and the pair of end plates 4 are stacked. Each stacked part 44 is provided with through holes 6c (see FIG. 6) that fasteners 16 pass through. Battery stack 2 and the pair of end plates 4 are sandwiched between the pair of restraint members 6 in stacking direction X.

Covering 8 is also called a top cover and is disposed so as to cover a surface of battery stack 2 adjacent to the projecting output terminals of batteries 12. Covering 8 is made of a resin having an insulation property, for example. Covering 8 prevents condensed water, dust, and other foreign matter from coming into contact with parts such as output terminals 22 of batteries 12, the bus bars, and valves 24 described later.

Fastener 16 is a component used to fasten the pair of restraint members 6 to the pair of end plates 4. Fasteners 16 fasten stacked parts 44 of restraint members 6 to end plates 4. Fastener 16 has protrusion 46 projecting from stacked part 44 in stacking direction X. In the present exemplary embodiment, fastener 16 is a fastening screw, for example. Protrusion 46 is a head of the fastening screw.

Battery module 1 is assembled as follows, for example. Specifically, first, the plurality of batteries 12 and the plurality of separators 14 are alternately stacked, and are sandwiched between the pair of end plates 4. Accordingly, an assemblage is formed. Then, the pair of restraint members 6 is mounted on this assemblage. The assemblage partly enters a space between the pairs of stacked parts 44 of restraint members 6. Each restraint member 6 is aligned such that through holes 6c overlap screw holes 4a of end plates 4.

Then, fasteners 16 are inserted into through holes 6c and are screwed into screw holes 4a. As a result, the plurality of batteries 12 and the plurality of separators 14 are fastened together by the pair of end plates 4 and the pair of restraint members 6. The plurality of batteries 12 is tightened by restraint members 6 in stacking direction X of batteries 12. In this state, the bus bars are electrically connected to the output terminals of batteries 12. Subsequently, covering 8 is attached to a top surface of battery stack 2. Battery module 1 is obtained through the above-described steps.

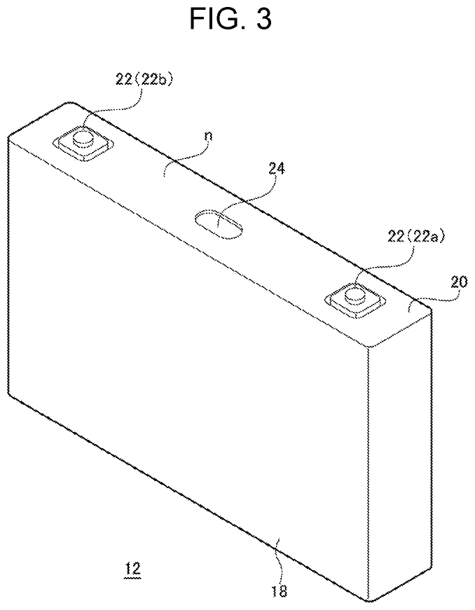

Next, a detailed description will be given of structures of battery 12, separator 14, end plate 4, and restraint member 6. FIG. 3 is a schematic perspective view illustrating a structure of battery 12. Battery 12 has exterior can 18 with a flat rectangular parallelepiped shape. A substantially rectangular opening is provided on one surface of exterior can 18, and an electrode assembly, an electrolyte, and the like are put into exterior can 18 through this opening. The opening of exterior can 18 is provided with sealing plate 20 to seal an inside of exterior can 18. Sealing plate 20 has positive-electrode output terminal 22 (positive electrode terminal 22a) near one end in a longitudinal direction and negative-electrode output terminal 22 (negative electrode terminal 22b) near the other end in the longitudinal direction. Hereinafter, when there is no need to distinguish polarities of output terminal 22, positive electrode terminal 22a and negative electrode terminal 22b are collectively referred to as output terminal 22. Sealing plate 20 and output terminals 22 constitute a sealing body. Exterior can 18 and sealing plate 20 are each formed from a metal. Typically, exterior can 18 and sealing plate 20 are each formed from a metal such as aluminum or an aluminum alloy. Output terminal 22 is formed from a metal having electrical conductivity.

In the present exemplary embodiment, a side provided with the sealing body serves as top surface n of battery 12, and an opposite side serves as a bottom surface of battery 12. Further, battery 12 has two main surfaces connecting top surface n and the bottom surface. This main surface is a surface having a largest area among six surfaces of battery 12. Remaining two surfaces excluding top surface n, the bottom surface, and the two main surfaces serve as side surfaces of battery 12. A top surface side of batteries 12 serves as the top surface of battery stack 2, and a bottom surface side of batteries 12 serves as a bottom surface of battery stack 2.

Battery 12 has valve 24 on a surface to release gas produced inside battery 12. In the present exemplary embodiment, battery 12 has valve 24 on top surface n. Valve 24 is disposed between a pair of output terminals 22 of sealing plate 20. Specifically, valve 24 is disposed substantially at a center of sealing plate 20 in the longitudinal direction. Valve 24 can be opened to release internal gas when internal pressure of exterior can 18 rises to a predetermined value or more. Valve 24 is also called a safety valve or a vent.

The plurality of batteries 12 is disposed such that the main surfaces of adjacent batteries 12 face each other and output terminals 22 face in an identical direction (for convenience of description, upward in a vertical direction in this example). Two adjacent batteries 12 are arrayed such that positive electrode terminal 22a of one of the batteries is adjacent to negative electrode terminal 22b of the other battery. Positive electrode terminal 22a and negative electrode terminal 22b are electrically connected via a bus bar.

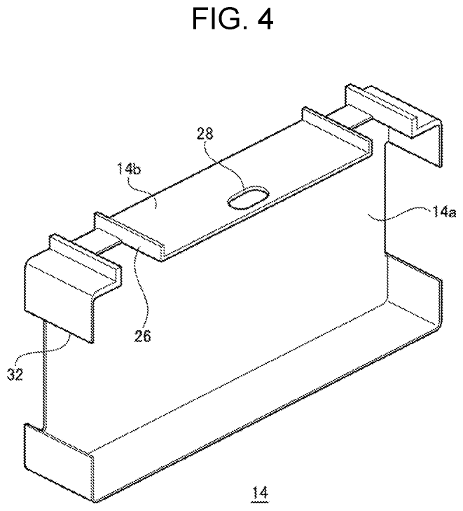

FIG. 4 is a schematic perspective view illustrating a structure of separator 14. Separator 14 has plane 14a parallel to the main surface of battery 12 and wall 14b extending from a peripheral edge of plane 14a in stacking direction X of batteries 12. Since plane 14a extends between the main surfaces of adjacent batteries 12, exterior cans 18 of adjacent batteries 12 are insulated from each other. Further, since plane 14a extends between battery 12 and end plate 4, exterior can 18 of battery 12 and end plate 4 are insulated from each other.

Top surface n, the bottom surface, and the side surfaces of battery 12 are covered with wall 14b. This can suppress a short circuit between adjacent batteries 12 or between battery 12 and end plate 4, which can be caused by, for example, dew condensation on a surface of battery 12 or end plate 4. In other words, a creepage distance between adjacent batteries 12 or between battery 12 and end plate 4 can be secured by wall 14b. In particular, wall 14b covers top surface n of battery 12, whereby the above-described short circuit can be further suppressed. In the present exemplary embodiment, a tip of wall 14b of one of two adjacent separators 14 abuts on a periphery of plane 14a of the other separator. Therefore, battery 12 is housed in a space formed by plane 14a and wall 14b. In the present exemplary embodiment, separator 14 holds battery 12 by way of wall 14b.

Wall 14b covering top surface n of battery 12 has cutouts 26 at positions corresponding to output terminals 22 to expose output terminals 22 to the outside. Wall 14b covering top surface n of battery 12 has opening 28 at a position corresponding to valve 24 to expose valve 24 to the outside. Wall 14b covering the side surfaces of battery 12 has cutouts 32 to expose the side surfaces of battery 12.

FIG. 5 is a schematic perspective view illustrating a structure of end plate 4. End plate 4 has two thin-walled parts 34 and one thick-walled part 36. Two thin-walled parts 34 are positioned at both ends of the end plate in direction Y perpendicular to stacking direction X. Direction Y perpendicular to stacking direction X is a direction in which the pair of restraint members 6 is arrayed. Thick-walled part 36 is positioned between two thin-walled parts 34. Thick-walled part 36 is thicker than thin-walled parts 34 in stacking direction X. Thin-walled parts 34 each have a thickness of 5 mm to 20 mm, for example. Thick-walled part 36 has a thickness of 10 mm to 30 mm, for example. A ratio of each thin-walled part 34 to thick-walled part 36 in length in direction Y perpendicular to stacking direction X is 2:3, for example. Each thin-walled part 34 has screw holes 4a.

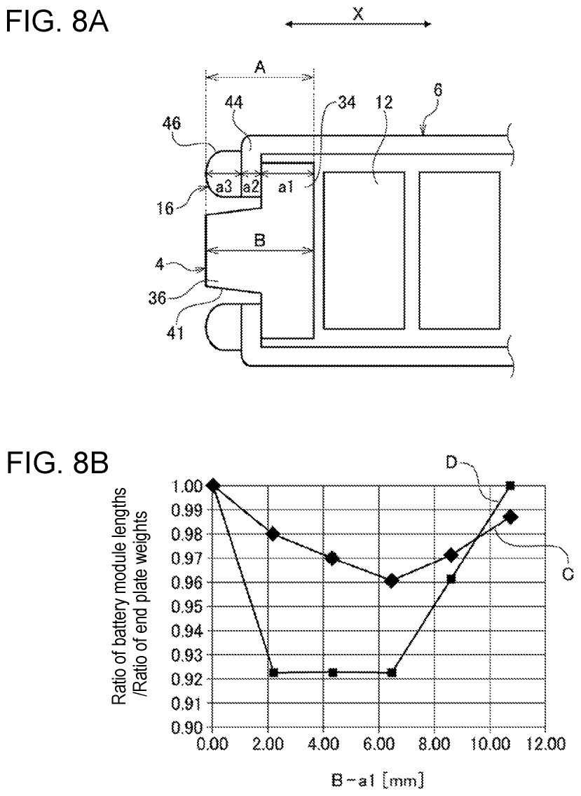

A surface of thick-walled part 36 remote from battery stack 2 forms plane 38 extending parallel to a surface of the thick-walled part adjacent to battery stack 2. Plane 38 possessed by thick-walled part 36 facilitates installation of a plurality of battery modules 1. Boundary 40 between thin-walled part 34 and thick-walled part 36 has a round shape. Corner 42 of thick-walled part 36, i.e. a place where a lateral surface connecting boundary 40 with plane 38 and plane 38 meets, has a round shape. Round-shaped boundary 40 and corner 42 hinder stress applied to end plate 4 in response to expansion of battery 12 from being concentrated on boundary 40 and corner 42. Preferably, lateral surface 41 connecting boundary 40 with corner 42 is tilted relative to stacking direction X in which to stack the plurality of batteries 12 that constitutes battery stack 2 (see FIG. 8A). In other words, it is preferred that thick-walled part 36 be shaped such that a length of the thick-walled part in direction Y perpendicular to stacking direction X gradually decreases with an increase in distance from thin-walled parts 34 in stacking direction X. This configuration further hinders stress applied to end plate 4 in response to expansion of battery 12 from being concentrated on boundary 40 and corner 42.

FIG. 6 is a schematic perspective view illustrating a structure of restraint member 6. Restraint member 6 includes rectangular plane 6a parallel to a side surface of battery stack 2, eaves parts 6b projecting from edges of an upper side and a lower side of plane 6a toward battery stack 2, and stacked parts 44 projecting from edges of a left side and a right side of plane 6a toward battery stack 2. In other words, restraint member 6 has stacked parts 44 on both ends in stacking direction X of batteries 12. Restraint member 6 can be formed by folding each side of a rectangular metal plate, for example.

Plane 6a is provided with opening 6d to expose the side surface of battery stack 2. Opening 6 is disposed so as to face cutouts 32 of separators 14. Opening 6d contributes to a reduction in weight of restraint member 6. Restraint member 6 may be provided with a plurality of openings as needed. In assembled battery module 1, wall 14b is positioned between restraint member 6 and battery 12 (see FIGS. 1 and 2). This configuration prevents restraint member 6 and battery 12 from coming into contact with each other. Each stacked part 44 is provided with a plurality of through holes 6c.

The plurality of batteries 12 is tightened by the pair of restraint members 6 in stacking direction X of batteries 12 and is thereby aligned in stacking direction X. Furthermore, bottom surfaces of batteries 12 make contact with lower eaves parts 6b of restraint members 6 with separators 14 interposed therebetween, and top surfaces of batteries 12 make contact with upper eaves parts 6b of restraint members 6 with separators 14 interposed therebetween. This configuration aligns the plurality of the batteries in a vertical direction.

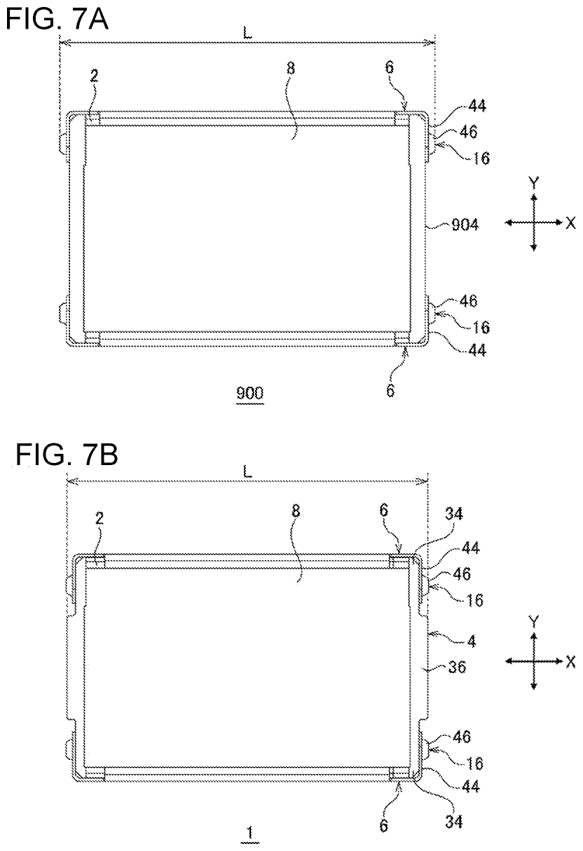

Next, a fastening structure of end plates 4 and restraint members 6 in battery module 1 will be described in detail. FIG. 7A is a schematic plan view illustrating a structure of a battery module according to a comparative example. FIG. 7B is a schematic plan view illustrating the structure of battery module 1 according to the exemplary embodiment. FIG. 8A is a schematic view for illustrating a relationship among thicknesses of thin-walled part 34, thick-walled part 36, stacked part 44, and protrusion 46. FIG. 8B is a graph illustrating a variation in a length of battery module 1 and a variation in a weight of end plate 4 in response to a change in a difference between the thicknesses of thin-walled part 34 and thick-walled part 36.

In FIG. 8B, the horizontal axis represents difference (B−a1) (in units of mm) between thickness B of thick-walled part 36 and thickness a1 of thin-walled part 34. The vertical axis represents a ratio of battery module 1 of the exemplary embodiment to battery module 900 according to the comparative example of FIG. 7A in in stacking direction X. The vertical axis also represents a ratio of end plate 4 in battery module 1 of the exemplary embodiment to end plate 4 in battery module 900 of the comparative example in terms of weight. The length ratio is shown by rhombus plotted line C, and the weight ratio is shown by square plotted line D. The graph of FIG. 8B shows results of an analysis performed on condition that thickness difference (B−a1) is changed with stiffness of end plate 4 fixed at a predetermined value. The analysis was performed with a three-dimensional structure analysis tool using the finite element method. Conditions for the analysis are as described below. In other words, Young's modulus was set for each component, and a vibration assumed to be produced in the case of a vehicle collision was applied to the end plates to analyze strength of each component. Specifically, Young's modulus for the end plates was set at 70 GPa on the assumption that the end plates were made of an aluminum alloy. Young's modulus for the restraint members was set at 200 GPa on the assumption that the restraint members were made of a steel.

As shown in FIG. 7A, battery module 900 according to the comparative example includes a pair of end plates 904 having a uniform thickness. Stacked part 44 of restraint member 6 is fastened to a surface of each end plate 904. Thus, length L, a sum of a length between surfaces of the pair of end plates 4, thicknesses of two stacked part 44, and thicknesses of two protrusions 46, is equivalent to a dimension of battery module 900 in stacking direction X.

Meanwhile, as shown in FIG. 7B, the pair of end plates 4 included in battery module 1 according to the present exemplary embodiment each have two thin-walled parts 34. Stacked part 44 of one restraint member 6 is stacked on one thin-walled part 34 of each end plate 4, while stacked part 44 of other restraint member 6 is stacked on other thin-walled part 34 of the end plate. Stacked parts 44 are stacked on surfaces of thin-walled parts 34 remote from battery stack 2. Stacked parts 44 are fastened to thin-walled parts 34 by fasteners 16. Since stacked part 44 is fastened to thin-walled part 34 in this way, a thickness of stacked part 44 and protrusion 46 can be moderated by a thickness of thin-walled part 34. This contributes to a reduction in a dimension of battery module 1 in stacking direction X. As a result, battery module 1 can come down in size.

End plate 4 also has thick-walled part 36. If a number of batteries 12 is increased, mass of battery module 1 increases. Both ends of end plate 4 are fastened to restraint members 6. Accordingly, if an impact due to a vehicle collision or other reason is exerted on battery module 1, force is applied to end plate 4 such that a middle of end plate 4 is pressed outward. This force increases with a rise in the mass of batteries 12. This requires end plates 4 to provide improved stiffness. To meet this requirement, end plate 4 has thick-walled part 36 and hence provides improved stiffness. This results in an improvement in stiffness of battery module 1.

Thick-walled part 36 projects outward of end plate 4 in stacking direction X and into a region between two fasteners 16. Thus, thick-walled part 36 is disposed in an intrinsically dead space between two fasteners 16. This configuration can improve a rate of utilization of space in battery module 1. This configuration prevents thick-walled part 36 from contributing to an increase in the dimension of battery module 1 in stacking direction X.

In the present exemplary embodiment, as shown in FIG. 8A, thickness A, a sum of thickness a1 of thin-walled part 34, thickness a2 of stacked part 44, and thickness a3 of protrusion 46, is equal to thickness B of thick-walled part 36 in stacking direction X. As a result, battery module 1 can achieve a balance between downsizing and stiffness improvement at a high level. The “equal” mentioned herein includes a state in which thicknesses A and B differ from each other due to dimensional tolerance. A difference between thicknesses A and B due to a dimensional tolerance is, for example, 1.0 mm.

As shown in FIG. 8B, difference (B−a1) in thickness between thin-walled part 34 and thick-walled part 36 is preferably greater than 0 mm and less than 10.7 mm and is more preferably greater than or equal to 2.2 mm and less than or equal to 8.6 mm. Further preferably, the thickness difference is 6.4 mm. In FIG. 8B, values of difference (B−a1) at rightmost plots on lines C and D are 10.7 mm. Values of difference (B−a1) at second plots from the left on the lines are 2.2 mm, values of difference (B−a1) at second plots from the right are 8.6 mm, and values of difference (B−a1) at third plots from the right are 6.4 mm. If end plate 4 is designed such that the difference in thickness between thin-walled part 34 and thick-walled part 36 falls within this range, battery module 1 can be made shorter than battery module 900 of the comparative example in stacking direction X, and end plate 4 can be made lighter in weight.

As described above, battery module 1 according to the present exemplary embodiment includes battery stack 2, the pair of end plates 4 disposed on both ends of battery stack 2, the pair of restraint members 6 to sandwich battery stack 2 and the pair of end plates 4 therebetween in stacking direction X of batteries 12, and fasteners 16 to fasten restraint members 6 to end plates 4. Each end plate 4 has two thin-walled parts 34 at both ends in direction B perpendicular to stacking direction X and thick-walled part 36 between two thin-walled parts 34. Restraint member 6 has stacked parts 44 that are stacked on surfaces of thin-walled parts 34. Stacked parts 44 are fastened to thin-walled parts 34.

Since restraint members 6 are fastened to thin-walled parts 34 in this way, battery module 1 can be made shorter in stacking direction X than battery module 900 that includes end plates 904 having a uniform thickness. As a result, battery module 1 can come down in size.

End plate 4 has thick-walled part 36 between two thin-walled parts 34 and hence provides improved stiffness. In other words, end plate 4 ensures stiffness because of thick-walled part 36 and thus end plate 4 can have thin-walled parts 34 that can possibly lower the stiffness of end plate 4 because of the thin thickness. If end plate 4 simply gets thicker to offer increased stiffness, the dimension of battery module 1 increases. In contrast, end plates 4 in the present exemplary embodiment ensure stiffness because of thick-walled parts 36 while thin-walled parts 34 contribute to downsizing of battery module 1.

Since thick-walled part 36 is disposed between two thin-walled parts 34, a space between two fasteners 16 that has conventionally not been used is efficiently utilized. This configuration can improve the rate of utilization of space in battery module 1 and allows battery module 1 to be made more compact.

Dimensions of end plate 4, restraint member 6, and fastener 16 are specified such that thickness A, a sum of thickness a1 of thin-walled part 34, thickness a2 of stacked part 44, and thickness a3 of protrusion 46, is equal to thickness B of thick-walled part 36. As a result, battery module 1 can achieve a balance between downsizing and stiffness improvement at a high level. The difference in thickness between thin-walled part 34 and thick-walled part 36 is set to a value in a range of greater than 0 mm to less than 10.7 mm. Thus, battery module 1 can achieve both downsizing and weight reduction.

The present invention is not limited to the above-described exemplary embodiment, and modifications, such as various design changes, can be added thereto based on knowledge of the person of ordinary skill in the art. The modified exemplary embodiments are also included in the scope of the present invention. A new exemplary embodiment made by adding modifications to the above-described exemplary embodiment has effects of the combined or modified exemplary embodiments.

In the above-described exemplary embodiment, battery 12 is a prismatic battery. However, a shape of battery 12 is not particularly limited and may be cylindrical, for example. Further, a number of batteries 12 included in battery stack 2 is not particularly limited. Moreover, exterior can 18 may be covered with an insulating sheet, such as a shrink tube.

Any desired combinations of the above-described components and converted expressions of the present invention in methods, devices, systems, and other similar entities are still effective as aspects of the present invention.

1. A battery module comprising:
a battery stack including a plurality of stacked batteries;
a pair of end plates disposed on both ends of the battery stack in a stacking direction in which the batteries are stacked, the end plates each including two thin-walled parts at both ends in a direction perpendicular to the stacking direction and a thick-walled part disposed between the two thin-walled parts, the thick-walled part being thicker than the thin-walled parts in the stacking direction;
a pair of restraint members each including a stacked part stacked on a surface of each of the thin-walled parts remote from the battery stack, the pair of the restraint members sandwiching the battery stack and the pair of end plates between the pair of the restraint members in the stacking direction; and
a fastener to fasten the stacked part of one of the restraint members to one of the thin-walled parts and to fasten the stacked part of another of the restraint members to another of the thin-walled parts.

2. The battery module according to claim 1, wherein
the fastener has a protrusion projecting from the stacked part in the stacking direction, and
a thickness A, that is a sum of thicknesses of any one of the thin-walled parts, the stacked part, and the protrusion, is equal to a thickness B of the thick-walled part in the stacking direction.

3. The battery module according to claim 1, wherein a difference in thickness between each of the thin-walled parts and the thick-walled part is greater than 0 mm and less than 10.7 mm.

4. The battery module according to claim 1, wherein the thick-walled part is shaped such that a length of the thick-walled part in a direction perpendicular to the stacking direction gradually decreases with an increase in distance from the thin-walled parts in the stacking direction.

5. The battery module according to claim 2, wherein a difference in thickness between each of the thin-walled parts and the thick-walled part is greater than 0 mm and less than 10.7 mm.
